(19) United States
(12) Patent Application Publication
(10) Pub. No.: US 2010/0052529 A1
(43) Pub. Date: Mar. 4, 2010

(54) PLASMA DISPLAY PANEL

(76) Inventors: Tae-Jun Kim, Suwon-si (KR); Woo-Joon Chung, Suwon-si (KR)

Correspondence Address: CHRISTIE, PARKER & HALE, LLP, PO BOX 7068, PASADENA, CA, 91109-7068, US

(21) Appl. No.: 12/403,204

(22) Filed: Mar. 12, 2009

Related U.S. Application Data
(60) Provisional application No. 61/190,867, filed on Sep. 2, 2008.

(51) Int. Cl. H01J 17/49

(52) U.S. Cl. 313/582

(57) ABSTRACT

A plasma display panel with improved power efficiency and visual characteristics and contrast. The plasma display panel includes a first substrate and a second substrate facing the first substrate. A plurality of barrier ribs are on a side of the first substrate facing the second substrate and define a plurality of discharge cells. Sustain electrodes and scan electrodes extend on a side of the second substrate facing the first substrate, and each of the sustain electrodes and the scan electrodes has a bus electrode. One of the scan electrodes forms a discharge gap with a corresponding one of the sustain electrodes, wherein one of the sustain electrodes corresponds to two adjacent rows of discharge cells among the plurality of discharge cells, and the bus electrode of the one of the scan electrodes is adjacent to the discharge gap.

### CROSS-REFERENCE TO RELATED APPLICATIONS

This application claims priority to and the benefit of U.S. Provisional Patent Application No. 61/190,867 filed on Sep. 2, 2008, the entire content of which is incorporated herein by reference.

### BACKGROUND OF THE INVENTION

1. (a) Field of the Invention

The present invention relates to a plasma display panel (PDP) and, more particularly, to a PDP with improved power efficiency and visual characteristics and contrast.

2. (b) Description of the Related Art

A PDP is a display device which displays images through gas discharges in the discharge cells of the PDP. That is, the gas discharges generate plasma in the discharge cells, and the plasma emits vacuum ultraviolet (VUV) rays that excite phosphors in the discharge cells. The phosphors generate visible light of red (R), green (G), and blue (B) as they are stabilized from an excited state.

In one example, an AC type PDP has discharge cells that are formed by providing barrier ribs between a rear substrate and a front substrate. Address electrodes are provided on the rear substrate to correspond to the discharge cells, and display electrodes (e.g., sustain electrodes and scan electrodes) are formed on a side of the front substrate facing the address electrodes. The sustain electrodes and the scan electrodes are each formed of a transparent electrode and an opaque bus electrode.

The discharge cells can be defined by the display electrodes and the barrier ribs. For example, when the PDP has a rectangular barrier rib structure, rectangular discharge cells are formed by crossing regions of longitudinal barrier ribs and horizontal barrier ribs that are crossing the longitudinal barrier ribs. In the rectangular barrier rib structure, display electrodes overlap the discharge spaces of the rectangular discharge cells. As a result, a wide discharge space is ensured, and this leads to a high luminance output per discharge and a large margin for discharge, but reduces the aperture ratio of the PDP due to the bus electrodes of the display electrodes, thus lowering the utilization efficiency of visible light generated by the discharge. When the discharge space is wide, discharge time delay may not increase as operation time increases.

In another example, in a PDP with a double-layered barrier rib structure, horizontal barrier ribs are formed with double layers, thus forming a non-discharge space in one direction between the discharge cells. In the double-layered barrier rib structure, the display electrodes are disposed to overlap the barrier ribs. That is, the bus electrodes of the display electrodes are arranged to overlap the barrier ribs. As a result, the aperture ratio of the PDP is increased, but the discharge space is decreased, thus leading to a smaller margin for discharge, an increase of discharge time delay and a low luminance output per discharge.

Generally, regarding luminance efficiency, the double-layered barrier rib structure is superior to the rectangular barrier rib structure in a region of a PDP with a large discharge load, such as a full white image, while the double-layered barrier rib structure is inferior to the rectangular barrier rib structure at a load of 10-30%, which is typical of a moving image condition. This is because, in the double-layered barrier rib structure, the number of sustain pulses has to be higher than that of the rectangular barrier rib structure in order to provide the same luminance, and hence reactive power consumption is increased.

### SUMMARY OF THE INVENTION

An exemplary embodiment of the present invention provides a plasma display panel with improved efficiency by reducing reactive power consumption.

Furthermore, an exemplary embodiment of the present invention provides a plasma display panel with improved visual characteristics and contrast by symmetrically arranging black portions of the plasma display panel.

According to an embodiment of the present invention, a plasma display panel includes: a first substrate; a second substrate facing the first substrate; a plurality of barrier ribs on a side of the first substrate facing the second substrate and defining a plurality of discharge cells; and sustain electrodes and scan electrodes extending on a side of the second substrate facing the first substrate. Each of the sustain electrodes and the scan electrodes has a bus electrode. One of the scan electrodes forms a discharge gap with a corresponding one of the sustain electrodes. One of the sustain electrodes corresponds to two adjacent rows of discharge cells among the plurality of discharge cells, and the bus electrode of the one of the scan electrodes is adjacent to the discharge gap.

A first scan electrode of the scan electrodes may correspond to a first row of discharge cells of the two adjacent rows of discharge cells, and the bus electrode of the first scan electrode may overlap a discharge region of the first row of discharge cells.

A second scan electrode of the scan electrodes may correspond to a second row of discharge cells of the two adjacent rows of discharge cells, and the bus electrode of the second scan electrode may overlap a discharge region of the second row of discharge cells.

The plasma display panel may further include a plurality of black stripes extending on the side of the second substrate facing the first substrate and being substantially in parallel with the scan electrodes and the sustain electrodes. The first scan electrode, the second scan electrode and the one of the sustain electrodes may extend between and may be substantially in parallel with two corresponding black stripes of the plurality of black stripes.

The plurality of black stripes may include a conductive material.

The conductive material may include a material selected from the group consisting of Cr—Cu—Cr and Ag.

Each of the plurality of black stripes may overlap a corresponding one of the barrier ribs.

The plurality of black stripes and the bus electrodes of the scan electrodes may be symmetrically arranged with respect to the bus electrode of a corresponding one of the sustain electrodes that forms discharge gaps with the scan electrodes.

The plurality of black stripes, the bus electrodes of the scan electrodes and the bus electrodes of the sustain electrodes may be substantially evenly spaced apart from each other.

According to another embodiment of the present invention, a plasma display panel includes: a first substrate; a second substrate facing the first substrate; a plurality of barrier ribs on a side of the first substrate facing the second substrate and defining a plurality of discharge cells; and black stripes, first electrodes and second electrodes extending on a side of the second substrate facing the first substrate. Each of the first electrodes and the second electrodes has a bus electrode. One of the first electrodes forms discharge gaps with two corresponding second electrodes of the second electrodes. The black stripes and the bus electrodes of the two corresponding second electrodes are symmetrically arranged with respect to the bus electrode of the one of the first electrodes that forms the discharge gaps with the two corresponding second electrodes.

The black stripes, the bus electrodes of the first electrodes and the bus electrodes of the second electrodes may be substantially evenly spaced apart from each other.

Each of the black stripes may overlap with a corresponding one of the barrier ribs.

Each of the first electrodes may correspond to two adjacent rows of the plurality of discharge cells, and each of the second electrodes may correspond to one row of the plurality of discharge cells.

One of the first electrodes and two of the second electrodes may extend between two corresponding black stripes of the plurality of black stripes.

The one of the first electrodes may extend between the two of the second electrodes.

Each of the bus electrodes of the first electrodes may overlap with a corresponding one of the barrier ribs.

Each of the bus electrodes of the second electrodes may overlap with a discharge region between two corresponding barrier ribs of the barrier ribs.

One of the first electrodes may be configured to perform a discharge with two of the second electrodes.

The two of the second electrodes may be on opposite sides of the one of the first electrodes.

According to yet another embodiment of the present invention, a plasma display device includes: a chassis base; a scan driver for applying scan signals, the scan driver being on a first side of the chassis base; a sustain driver for applying sustain signals, the sustain driver being on the first side of the chassis base; and a plasma display panel on a second side of the chassis base. The plasma display panel includes: a first substrate; a second substrate facing the first substrate; a plurality of barrier ribs on a side of the first substrate facing the second substrate and defining a plurality of discharge cells; and sustain electrodes and scan electrodes extending on a side of the second substrate facing the first substrate. Each of the sustain electrodes and the scan electrodes includes a bus electrode. One of the scan electrodes forms a discharge gap with a corresponding one of the sustain electrodes. The scan electrodes are configured to receive the scan signals, and the sustain electrodes are configured to receive the sustain signals. A sustain electrode of the sustain electrodes corresponds to two adjacent rows of discharge cells among the plurality of discharge cells, and the bus electrode of the one of the scan electrodes is adjacent to the discharge gap.

A first scan electrode of the scan electrodes may correspond to a first row of discharge cells of the two adjacent rows of discharge cells, and the bus electrode of the first scan electrode may overlap a discharge region of the first row of discharge cells.

A second scan electrode of the scan electrodes may correspond to a second row of discharge cells of the two adjacent rows of discharge cells, and the bus electrode of the second scan electrode may overlap a discharge region of the second row of discharge cells.

The plasma display panel may further include a plurality of black stripes extending on the side of the second substrate facing the first substrate and being substantially in parallel with the scan electrodes and the sustain electrodes. The first scan electrode, the second scan electrode and the sustain electrode may extend between and may be substantially in parallel with two corresponding black stripes of the plurality of black stripes.

The plurality of black stripes may include a conductive material.

The conductive material may include a material selected from the group consisting of Cr—Cu—Cr and Ag.

Each of the plurality of black stripes may overlap a corresponding one of the barrier ribs.

### BRIEF DESCRIPTION OF THE DRAWINGS

FIG. 1 is a schematic drawing illustrating an exploded perspective view of a plasma display panel (PDP) according to an exemplary embodiment of the present invention.

FIG. 2 is a schematic drawing illustrating a cross sectional view of the PDP taken along the line II-II of FIG. 1.

FIG. 3 is a schematic drawing illustrating a plan view showing the arrangement relationship of barrier ribs and display electrodes of the PDP in FIG. 1.

FIG. 4 is a graph showing reactive power consumption ratios according to various electrode arrangements.

FIG. 5 is a graph showing address voltages of various electrode arrangements according to time of use.

FIG. 6 is a graph showing address discharge delays of various electrode arrangements according to time of use.

FIG. 7 is a schematic drawing illustrating an exploded perspective view of a plasma display device according to an embodiment of the present invention.

### DESCRIPTION OF REFERENCE NUMERALS INDICATING PRIMARY ELEMENTS IN THE DRAWINGS

| | | | |
|---|---|---|---|
| 1 | plasma display panel | 10 | rear substrate |
| | (PDP) | | |
| 20 | front substrate | 30 | barrier ribs |
| 40 | display electrodes | 11 | address electrodes |
| 13, 21 | first and second | 17 | discharge cells |
| | dielectric layers | | |
| 117, 217 | first and second | 19 | phosphor layer |
| | discharge cells | | |
| 23 | protective layer | | |
| 31, 32 | first and second barrier | | |
| | ribs | | |
| 41 | sustain electrodes | 42 | scan electrodes |
| 41a, 42a | transparent electrodes | | |
| 141a, 241a | first and second | | |
| | transparent electrodes | | |
| 41b, 42b | bus electrodes | W411, W412, | width |
| | | W42 | |
| 43 | conductive black | DG | discharge gap |
| | stripes | | |

### DETAILED DESCRIPTION OF EXEMPLARY EMBODIMENTS

The present invention will be described more fully hereinafter with reference to the accompanying drawings, in which exemplary embodiments of the present invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

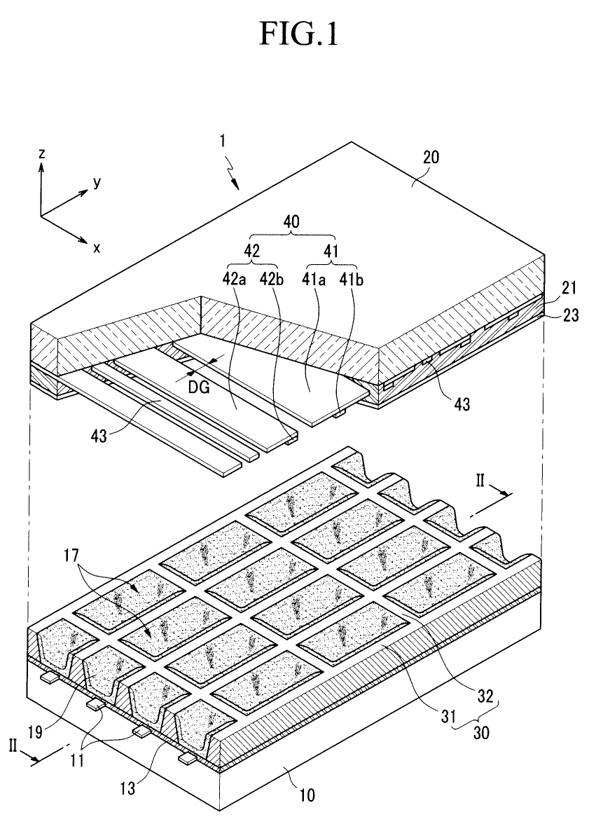

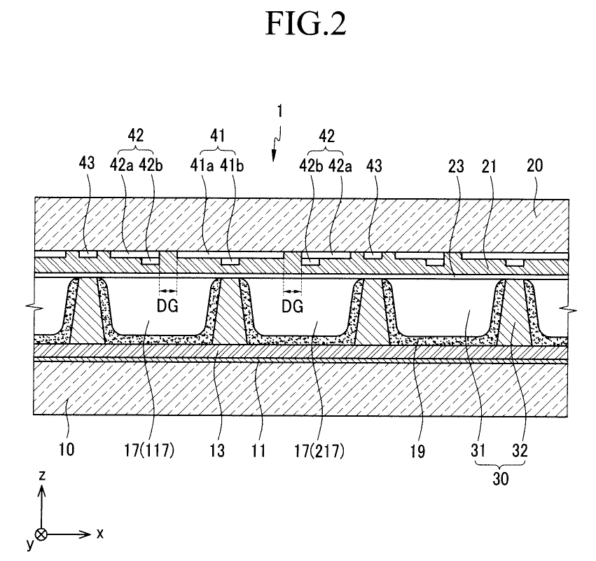

FIG. 1 is a schematic drawing illustrating an exploded perspective view of a plasma display panel (PDP) according to an exemplary embodiment of the present invention. FIG. 2 is a schematic drawing illustrating a cross sectional view of the PDP taken along the line II-II of FIG. 1.

Referring to FIGS. 1 and 2, the PDP 1, according to an exemplary embodiment of the present invention, includes a rear substrate 10 and a front substrate 20 spaced apart from and facing the rear substrate 10, and barrier ribs 30 arranged between the front and the rear substrates 20 and 10.

The barrier ribs 30 form a plurality of discharge cells 17 by partitioning the space between the rear substrate 10 and the front substrate 20. Each of the discharge cells 17 includes a phosphor layer 19, and is filled with a discharge gas, for instance, a gas containing a mix of neon (Ne) and xenon (Xe).

The discharge gas in the discharge cells is excited to generate gas discharges to generate vacuum ultraviolet rays, and the phosphor layers 19 in the discharge cells 17 are excited by the vacuum ultraviolet rays to emit visible light of red (R), green (G), and/or blue (B) as they are stabilized. To generate the gas discharges, address electrodes 11 and display electrodes 40 are applied with a discharge voltage to generate the gas discharges in the discharge cells 17.

In the exemplary embodiment shown in FIG. 1, the address electrodes 11 are formed to extend on an inner surface of the rear substrate 10 along the y-axis direction, and thus each of the address electrodes 11 corresponds to a row of the discharge cells 17 in y-axis direction. The address electrodes 11 extend in parallel with each other and respectively correspond to rows of the discharge cells 17, the rows being adjacent in the x-axis direction. A first dielectric layer 13 covers the inner surface of the rear substrate and the address electrodes 11. The first dielectric layer 13 protects the address electrodes 11 from the gas discharges by preventing positive ions or electrons from colliding directly with the address electrodes 11 at the time of discharge. Also, the first dielectric layer 13 provides a place where wall charges can be formed and accumulated, thus enabling an address discharge using a suitably low voltage.

Since the address electrodes 11 are arranged on the rear substrate 10, they do not interfere with the transmission of visible light through the front substrate 20. Therefore, the address electrodes 11 may be formed of opaque electrodes, e.g., metal electrodes, such as silver (Ag) electrodes that have excellent conductivity.

The barrier ribs 30 are provided on the first dielectric layer 13 of the rear substrate 10 to form the discharge cells 17 by partitioning the space between the substrates 10 and 20. For example, the barrier ribs 30 include first barrier ribs 31 extending in the y-axis direction and second barrier ribs 32 extending in the x-axis direction, and the second barrier ribs 32 are spaced apart from each other by a predetermined distance along the y-axis direction and cross the first barrier ribs 31.

That is, the first barrier ribs 31 define the boundaries of the discharge cells 17 adjacent to each other in the x-axis direction, and the second barrier ribs 32 define boundaries of the discharge cells 17 adjacent to each other in the y-axis direction. Accordingly, in the rectangular barrier rib structure, the discharge cells 17 have a matrix structure.

By way of example, the phosphor layer 19 is formed by depositing a phosphor paste on the sidewalls of the first barrier ribs 31, the sidewalls of the second barrier ribs 32 and a surface of the first dielectric layer 13 surrounded by the first barrier ribs 31 and the second barrier ribs 32. Furthermore, the deposited phosphor layer 19 is dried and fired.

In some embodiments, the phosphor layer 19 formed in a row of the discharge cells 17 extending in the y-axis direction is formed of phosphors for generating visible light of the same color. Furthermore, the phosphor layer 19 formed in a row of the discharge cells 17 in the x-axis direction are formed of phosphors for generating visible light of red (R), green (G) and blue (B). For example, the phosphor layer 19 formed of phosphors for generating visible light of R, G and B may have a repeated R, G and B pattern along the x-axis direction.

The display electrodes 40 include sustain electrodes 41 and scan electrodes 42. The sustain electrodes 41 and the scan electrodes 42 are provided on the inner surface of the front substrate 20 to correspond to the discharge cells 17. The sustain electrodes 41 and the scan electrodes 42 form a surface discharge structure corresponding to the discharge cells 17, and driving voltages are applied to the sustain electrodes 41 and the scan electrodes 42 to induce gas discharges in the discharge cells 17.

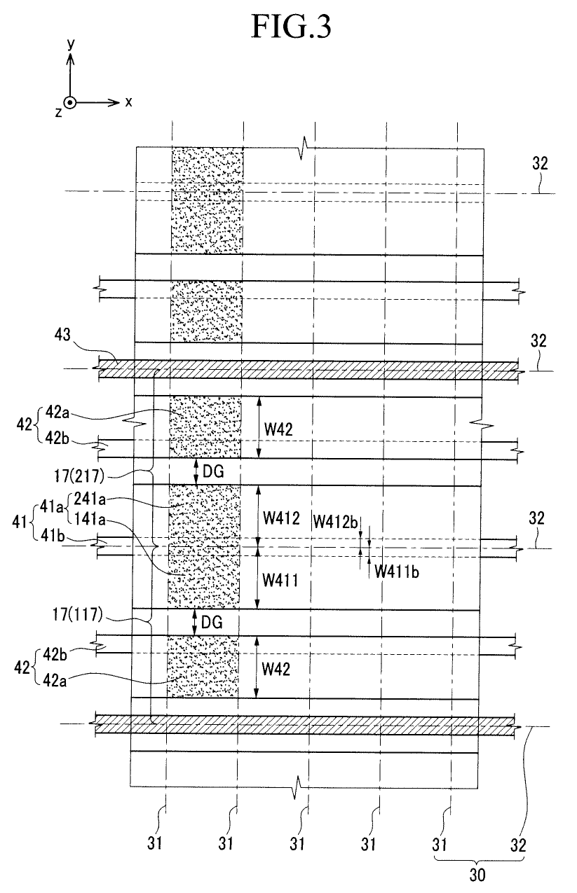

FIG. 3 is a schematic drawing illustrating a plan view showing the arrangement relationship of the barrier ribs and the display electrodes in the PDP of FIG. 1. Referring to FIG. 3, the sustain electrodes 41 and the scan electrodes 42 extend in parallel with each other along the x-axis and cross the address electrodes 11 (shown in FIGS. 1 and 2). Each of the sustain electrodes 41 includes a transparent electrode 41a for generating the discharges and a bus electrode 41b for applying voltage signals to the transparent electrode 41a. Each of the scan electrodes 42 includes a transparent electrode 42a for generating the discharges and a bus electrode 42b for applying voltage signals to the transparent electrode 42a.

The transparent electrodes 41a and 42a form discharge gaps DG substantially overlapping the center of the discharge cells 17, and the transparent electrodes 41a and 42a are formed of a transparent material, e.g., indium tin oxide (ITO), to provide a sufficient aperture ratio for the discharge cells 17. The bus electrodes 41b and 42b are formed over the transparent electrodes 41a and 42a, respectively, to apply voltage signals to the transparent electrodes 41a and 42a, and are constituted of, for example, metal so as to ensure sufficiently high electrical conductivity.

For example, the bus electrodes 41b and 42b are formed in a two-layer structure including a black layer (not shown) and a white layer (not shown), and the black layer is positioned to be visible from the outer side of the front substrate 20 opposite to the inner surface of the front substrate 20. Therefore, when viewed from the outer side of the front substrate 20, the bus electrodes 41b and 42b appear as black portions.

Hereinafter, the arrangement relationship of the sustain electrodes 41 and the scan electrodes 42 with respect to the barrier ribs 30 will be described. Also, the arrangement relationship of the transparent electrodes 41a and 42a and the bus electrodes 41b and 42b with respect to the second barrier ribs 32 will be described.

Regarding the arrangement relationship of the sustain electrodes 41 and the scan electrodes 42 with respect to the barrier ribs 30, the discharge cells 17 are arranged in connected pairs in the y-axis direction with a repetitive order along the y-axis direction. For the convenience of description, only a pair of discharge cells 17 connected in the y-axis direction including a first discharge cell 117 and a second discharge cell 217 will be described.

The sustain electrodes 41 are arranged to overlap the second barrier ribs 32 located at the centers between adjacent pairs of connected discharge cells 17, e.g., the first discharge cell 117 and the second discharge cell 217. Thus, the sustain electrode 41 of the first discharge cell 117 and the sustain electrode 41 of the second discharge cell 217 are adjacent to each other. In some embodiments, the sustain electrodes 41 of the first discharge cell 117 and the second discharge cell 217 may be connected and/or formed as a single electrode.

The first discharge cell 117 and the second discharge cell 217 are provided with different scan electrodes 42 that interact with the sustain electrodes 41 between the different scan electrodes 42, thereby providing the scan and sustain electrodes for generating the discharges in the first discharge cell 117 and the second discharge cell 217.

With respect to the first discharge cell 117 and the second discharge cell 217, the electrodes are arranged in an order of the scan electrode 42, the sustain electrode 41, the sustain electrode 41 and the scan electrode 42, and the two sustain electrodes 41 arranged at the center may be connected to each other. In some embodiments, the two sustain electrodes 41 may be formed as a single electrode. Since the sustain electrodes 41 to which the same voltage signal is applied are located at the sides of the discharge cells between first discharge cell 117 and the second discharge cell 217, electrostatic capacity (or capacitance) is reduced. As a result, reactive power consumption is reduced, and efficiency is improved.

The arrangement of the sustain electrodes 41 and the scan electrodes 42 will be further described hereinafter. For example, the transparent electrodes 41a of the sustain electrodes 41 extend and overlap the second barrier rib 32 between a pair of connected discharge cells 17. For example, with respect to the first and the second discharge cells 117 and 217, the transparent electrodes 41a respectively have electrode widths W411 and W412 in the direction toward the centers of the first and the second discharge cells 117 and 217, respectively, and transparent electrodes 41a are formed to extend in the x-axis direction. That is, the transparent electrodes 41a include a first transparent electrode 141a corresponding to the first discharge cell 117 and a second transparent electrode 241a corresponding to the second discharge cell 217. In addition, the first and the second transparent electrodes 141a and 241a may be formed of protrusion electrodes (not shown) that respectively correspond to the first and the second discharge cells 117 and 217.

With respect to the first and the second discharge cells 117 and 217, the bus electrodes 41b of the sustain electrodes 41 are arranged on the transparent electrodes 41a so as to overlap the second barrier rib 32 that is located between the first and the second discharge cells 117 and 217, and the bus electrodes 41b extend in the x-axis direction. A voltage signal applied to the bus electrodes 41b is applied to the first transparent electrode 141a and the second transparent electrode 241a. Since the bus electrodes 41b are arranged to overlap the second barrier rib 32, contrast may be improved without decreasing the aperture ratio and luminance of the discharge cells 17.

The bus electrodes 41b of the sustain electrodes 41 used for the first and the second discharge cells 117 and 217 are adjacent to each other or form a single electrode, hence, providing a wide line width, thus reducing line resistance. As a result, a voltage drop when a sustain pulse is applied to the sustain electrodes 41 is minimized or reduced, and a discharge margin is increased.

The bus electrodes 41b of the sustain electrodes 41 are positioned on positions far from the corresponding discharge gaps DG. The bus electrodes 41b may have the same width (i.e., W411b=W412b), for example, with respect to the first and the second discharge cells 117 and 217 as shown in FIG. 3, or may have different widths (i.e., W411b ≠W412b) (not shown).

The scan electrodes 42 are arranged to be on discharge regions of the first discharge cell 117 and the second discharge cell 217, respectively, and the first discharge cell 117 will be described first. With respect to the scan electrode 42 of the first discharge cell 117, the transparent electrode 42a is formed to overlap a portion of the discharge region of the first discharge cell 117 and is spaced apart in the y-axis direction from the first transparent electrode 141a so as to form the discharge gap DG between the transparent electrode 42a and the first transparent electrode 141a of the sustain electrode 41. The transparent electrode 42a has a width W42 corresponding to the width W411 of the first transparent electrode 141a of the sustain electrode 41, and is formed to extend in the x-axis direction. In some embodiments, the transparent electrodes 42a of the scan electrodes 42 may be formed of protrusion electrodes respectively corresponding to the first and the second discharge cells 117 and 217 (not shown).

With respect to the scan electrode 42 of the first discharge cell 117, the bus electrode 42b extends along a side of the transparent electrode 42a that forms the discharge gap DG, and overlaps substantially the central portion of the discharge region of the first discharge cell 117. Also, the bus electrode 42b extends in the x-axis direction. A voltage signal applied to the bus electrode 42b is applied to the transparent electrode 42a. Since the bus electrode 42b overlaps the central portion of the discharge region of the first discharge cell 117, the aperture ratio and luminance of the first discharge cell 117 may be reduced. However, the first discharge cell 117 has a rectangular barrier rib structure defined by the first barrier ribs 31 and the second barrier ribs 32, so that the discharge cell 117 has a wide discharge space as compared to that of a double-layered barrier rib structure, thereby realizing a high luminance per discharge.

The transparent electrode 42a of the scan electrode 42 corresponding to the second discharge cell 217 overlaps a portion of the discharge region of the second discharge cell 217, and is spaced apart in the y-axis direction from the second transparent electrode 241a so as to form the discharge gap DG between the transparent electrode 42a and the second transparent electrode 241a of the sustain electrode 41. The transparent electrode 42a has a width W42 corresponding to the width W412 of the second transparent electrode 241a of the sustain electrode 41, and is formed to extend in the x-axis direction.

The bus electrode 42b of the scan electrode 42 extends along a side of the transparent electrode 42a that forms the discharge gap DG, and substantially overlaps the central portion of the discharge region of the second discharge cell 217. Also, the bus electrode 42b is formed to extend in the x-axis direction. A voltage signal applied to the bus electrode 42b is applied to the transparent electrode 42a. Since the bus electrode 42b overlaps the discharge region of the second discharge cell 217, the aperture ratio and luminance of the second discharge cell 217 may be decreased. However, the second discharge cell 217 has a rectangular barrier rib structure defined by the first barrier ribs 31 and the second barrier ribs 32, so that the second discharge cell 217 has a wide discharge space as compared to that of a double-layered barrier rib structure, thereby realizing a high luminance per discharge.

Unlike the sustain electrodes 41, each of the scan electrodes 42 overlaps the discharge region of the corresponding discharge cell 17 over its whole width, therefore an address discharge can be generated with a low voltage because a lot of discharge paths are formed between the scan electrodes 41 and the address electrodes 11, thereby increasing an address voltage margin. Each of the bus electrodes 42b of the scan electrodes 42 extends along the side of a corresponding one of the transparent electrodes 42a adjacent to the discharge gap DG, thus minimizing or reducing a voltage drop along the transparent electrodes 42a.

That is, the whole width of each of the scan electrodes 42 overlaps the discharge region of the corresponding discharge cell 17, and each of the bus electrodes 42b is adjacent to the corresponding discharge gap DG. Accordingly, the address voltage may be decreased, and an address discharge delay that may be generated due to a long period of use of the PDP can be prevented or reduced. Therefore, with respect to the first and the second discharge cells 117 and 217, the display electrodes 40 are arranged in an order of the scan electrode 42, the sustain electrode 41, the sustain electrode 41 and the scan electrode 42. As a result, this electrode arrangement reduces electrostatic capacity or capacitance between the first and the second discharge cells 117 and 217 that are adjacent to each other in the y-axis direction. Furthermore, reactive power consumption may be reduced. As the first barrier ribs 31 and the second barrier ribs 32 are formed in a rectangular barrier rib structure, they provide a wide discharge space in the discharge cells such as the first and the second discharge cells 117 and 217. Accordingly, luminance per discharge is improved.

In addition, conductive black stripes 43 are formed on the inner surface of the front substrate 20 so as to correspond to the second barrier ribs 32 that define outside walls of pairs of connected discharge cells 17 in the y-axis direction, for example, the first and the second discharge cells 117 and 217. That is, each of the conductive black stripes 43 has a width corresponding to the width of the corresponding second barrier rib 32 and is formed to extend in the x-axis direction, thereby absorbing external light without interfering with the aperture ratio and luminance of the discharge cells 17. Accordingly, contrast characteristics are improved. Additional conductive black stripes (not shown) may be further formed on the bus electrodes 41b of the sustain electrodes 41.

In addition, the conductive black stripes 43 may be formed by the same process that forms the conductive bus electrodes 41b and 42b so that an additional process is not needed as compared to a case of forming non-conductive black stripes. Accordingly, the manufacturing cost may be reduced.

Because the whole width of each of the transparent electrodes 42a of the scan electrodes 42 substantially overlaps the discharge region of the corresponding discharge cells 17 such as those of the first and the second discharge cells 117 and 217, and the bus electrodes 42b are disposed on the transparent electrodes 42a, the conductive black stripes 43 may be formed to overlap the second barrier ribs 32 that form the outside walls of pairs of connected discharge cells in the y-axis direction such as the first and the second discharge cells 117 and 217.

In addition, as for the bus electrodes 41b and 42b and the conductive black stripes 43, which are the black portions, for example, in the pair of the first and the second discharge cells 117 and 217. Each of the bus electrodes 41b of the sustain electrodes 41 extends and overlaps the second barrier rib 32 between the corresponding pair of connected discharge cells 17 adjacent in the y-axis, and the bus electrodes 42b of the scan electrodes 41 and the conductive black stripes 43 are symmetrically arranged with respect to the corresponding bus electrodes 41b, thereby improving visual characteristics.

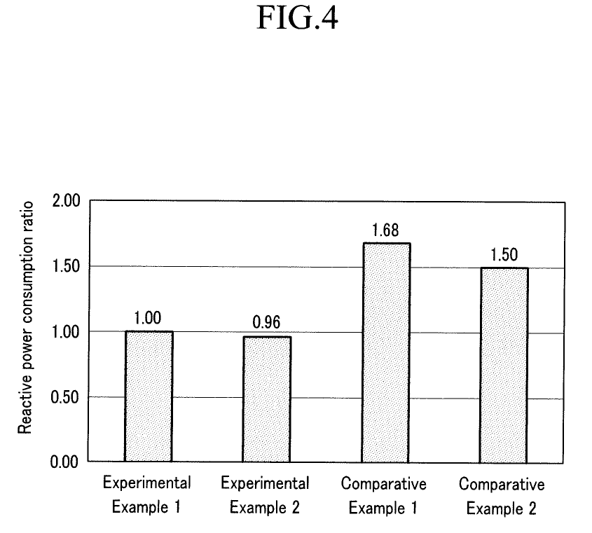

FIG. 4 is a graph showing reactive power consumption ratios according to various electrode arrangements. Referring to FIG. 4, while the exemplary embodiment of the present invention, that is, the arrangement order of the scan electrode 42, the sustain electrode 41, the sustain electrode 41, and the scan electrode 42, is applied to a rectangular barrier rib structure in Experimental Example 1 and Experimental Example 2, the arrangement order of a scan electrode, a sustain electrode, a scan electrode, and a sustain electrode is applied to a rectangular barrier rib structure in Comparative Example 1 and Comparative Example 2.

When the reactive power consumption ratios of Experimental Examples 1 and 2 are approximately 1, the reactive power consumption ratios of Comparative Examples 1 and 2 are equal to or greater than 1.5. Therefore, it can be seen that the reactive power consumption ratios of the Experimental Examples are reduced by about 30% compared to those of the Comparative Examples. As the reactive power consumption is reduced, the efficiency is improved.

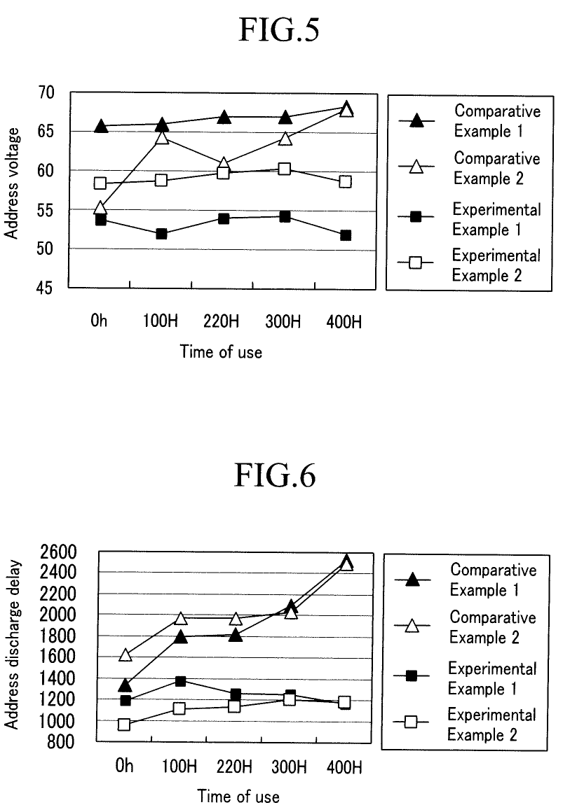

FIG. 5 is a graph showing address voltages according to the time of use of the PDP. Referring to FIG. 5, when the time of use is increased, the address voltage is increased in the Comparative Examples 1 and 2 whereas the address voltage is maintained at a substantially constant level in the Experimental Examples 1 and 2.

That is, the address voltage for the address discharge is not greatly changed when the time of use is increased according to the present embodiment, and accordingly a large discharge margin for the address discharge can be obtained.

FIG. 6 is a graph showing address discharge delays according to the time of use of the PDP. Referring to FIG. 6, when the time of use increases, an address discharge delay steeply increases after gradually increasing in the Comparative Examples 1 and 2 whereas the address discharge delay is maintained at a substantially constant level in the Experimental Examples 1 and 2.

Referring back to FIGS. 1 and 2, a second dielectric layer 21 covers the inner surface of the front substrate 20, the sustain electrodes 41, the scan electrodes 42 and the conductive black stripes 43. The second dielectric layer 21 protects the sustain electrodes 41 and the scan electrodes 42 from positive ions and electrons generated at the time of discharge, and provides a place where wall charges for a discharge are formed and accumulated.

A protective layer 23 covers the second dielectric layer 21. For example, the protective layer 23 is formed of transparent MgO for transmitting visible light through the protective layer 23. The protective layer 23 protects the second dielectric layer 21 from positive ions and electrons generated at the time of discharge and increases the second electron emission coefficient during the discharge.

For example, when driving the plasma display panel 1, a reset discharge occurs due to a reset pulse supplied to the scan electrodes 42 during a reset period. During a scan period subsequent to the reset period, address discharges occur due to scan pulses supplied to the scan electrodes 42 and address pulses supplied to the address electrodes 11. Thereafter, during a sustain period, sustain discharges occur due to sustain pulses supplied to the sustain electrodes 41 and the scan electrodes 42.

The sustain electrodes 41 and the scan electrodes 42 serve as electrodes for supplying the sustain pulses required for the sustain discharges. The scan electrodes 42 serve as electrodes for supplying the reset pulse and the scan pulse. The address electrodes 11 serve as electrodes for supplying the address pulse.

However, the sustain electrodes 41, the scan electrodes 42, and the address electrodes 11 may have different roles according to the waveforms of the voltages supplied thereto, and thus the present invention is not limited to the aforementioned roles of the electrodes.

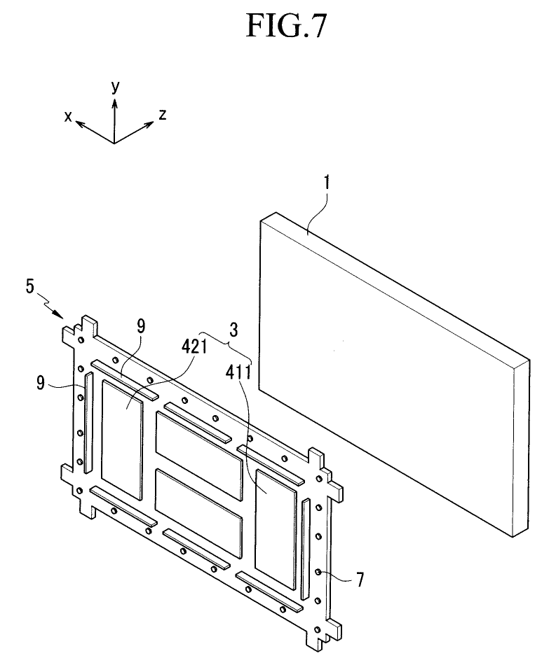

FIG. 7 is a schematic drawing illustrating an exploded perspective view of a plasma display device according to an embodiment of the present invention.

As shown in FIG. 7, a plasma display device according to an embodiment of the present invention includes a plasma display panel (PDP) 1 and a chassis base 5 for holding the PDP 1 and for installing driving circuit boards 3 thereon. The driving circuit boards 3 include the scan driver 421 and the sustain driver 411 for applying scan signals and sustain signals, respectively, to the scan electrodes 42 and the sustain electrodes 41.

The chassis base 5 is constructed of a pressed material. Many bosses 7 for installation of the driving circuit boards 3 are provided at a side of the chassis base 5. Ribs 9 in X- and/or Y-directions may be further provided to the chassis base 5 for increasing strength thereof.

While the present invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display panel comprising:
a first substrate;
a second substrate facing the first substrate;
a plurality of barrier ribs on a side of the first substrate facing the second substrate and defining a plurality of discharge cells; and
sustain electrodes and scan electrodes extending on a side of the second substrate facing the first substrate, each of the sustain electrodes and the scan electrodes having a bus electrode, one of the scan electrodes forming a discharge gap with a corresponding one of the sustain electrodes,
wherein one of the sustain electrodes corresponds to two adjacent rows of discharge cells among the plurality of discharge cells, and
the bus electrode of the one of the scan electrodes is adjacent to the discharge gap.

2. The plasma display panel of claim 1,
wherein a first scan electrode of the scan electrodes corresponds to a first row of discharge cells of the two adjacent rows of discharge cells, and
the bus electrode of the first scan electrode overlaps a discharge region of the first row of discharge cells.

3. The plasma display panel of claim 2,
wherein a second scan electrode of the scan electrodes corresponds to a second row of discharge cells of the two adjacent rows of discharge cells, and
the bus electrode of the second scan electrode overlaps a discharge region of the second row of discharge cells.

4. The plasma display panel of claim 3, further comprising a plurality of black stripes extending on the side of the second substrate facing the first substrate and being substantially in parallel with the scan electrodes and the sustain electrodes,
wherein the first scan electrode, the second scan electrode and the one of the sustain electrodes extend between and are substantially in parallel with two corresponding black stripes of the plurality of black stripes.

5. The plasma display panel of claim 4, wherein the plurality of black stripes comprise a conductive material.

6. The plasma display panel of claim 5, wherein the conductive material comprises a material selected from the group consisting of Cr—Cu—Cr and Ag.

7. The plasma display panel of claim 4, wherein each of the plurality of black stripes overlaps a corresponding one of the barrier ribs.

8. The plasma display panel of claim 4, wherein the plurality of black stripes and the bus electrodes of the scan electrodes are symmetrically arranged with respect to the bus electrode of a corresponding one of the sustain electrodes that forms discharge gaps with the scan electrodes.

9. The plasma display panel of claim 4, wherein the plurality of black stripes, the bus electrodes of the scan electrodes and the bus electrodes of the sustain electrodes are substantially evenly spaced apart from each other.

10. A plasma display panel comprising:
a first substrate;
a second substrate facing the first substrate;
a plurality of barrier ribs on a side of the first substrate facing the second substrate and defining a plurality of discharge cells; and
black stripes, first electrodes and second electrodes extending on a side of the second substrate facing the first substrate, each of the first electrodes and the second electrodes having a bus electrode, one of the first electrodes forming discharge gaps with two corresponding second electrodes of the second electrodes,
wherein the black stripes and the bus electrodes of the two corresponding second electrodes are symmetrically arranged with respect to the bus electrode of the one of the first electrodes that forms the discharge gaps with the two corresponding second electrodes.

11. The plasma display panel of claim 10, wherein the black stripes, the bus electrodes of the first electrodes and the bus electrodes of the second electrodes are substantially evenly spaced apart from each other.

12. The plasma display panel of claim 10, wherein each of the black stripes overlaps with a corresponding one of the barrier ribs.

13. The plasma display panel of claim 10,
wherein each of the first electrodes corresponds to two adjacent rows of the plurality of discharge cells, and
wherein each of the second electrodes corresponds to one row of the plurality of discharge cells.

14. The plasma display panel of claim 10, wherein one of the first electrodes and two of the second electrodes extend between two corresponding black stripes of the plurality of black stripes.

15. The plasma display panel of claim 14, wherein the one of the first electrodes extends between the two of the second electrodes.

16. The plasma display panel of claim 10, wherein each of the bus electrodes of the first electrodes overlaps with a corresponding one of the barrier ribs.

17. The plasma display panel of claim 10, wherein each of the bus electrodes of the second electrodes overlaps with a discharge region between two corresponding barrier ribs of the barrier ribs.

18. The plasma display panel of claim 10, wherein one of the first electrodes is configured to perform a discharge with two of the second electrodes.

19. The plasma display panel of claim 18, wherein the two of the second electrodes are on opposite sides of the one of the first electrodes.

20. A plasma display device comprising:
a chassis base;
a scan driver for applying scan signals, the scan driver being on a first side of the chassis base;
a sustain driver for applying sustain signals, the sustain driver being on the first side of the chassis base;
a plasma display panel on a second side of the chassis base and comprising:
a first substrate;
a second substrate facing the first substrate;
a plurality of barrier ribs on a side of the first substrate facing the second substrate and defining a plurality of discharge cells; and
sustain electrodes and scan electrodes extending on a side of the second substrate facing the first substrate, each of the sustain electrodes and the scan electrodes comprising a bus electrode, one of the scan electrodes forming a discharge gap with a corresponding one of the sustain electrodes, the scan electrodes being configured to receive the scan signals and the sustain electrodes being configured to receive the sustain signals,
wherein a sustain electrode of the sustain electrodes corresponds to two adjacent rows of discharge cells among the plurality of discharge cells, and
the bus electrode of the one of the scan electrodes is adjacent to the discharge gap.

21. The plasma display device of claim 20,
wherein a first scan electrode of the scan electrodes corresponds to a first row of discharge cells of the two adjacent rows of discharge cells, and
the bus electrode of the first scan electrode overlaps a discharge region of the first row of discharge cells.

22. The plasma display device of claim 21,
wherein a second scan electrode of the scan electrodes corresponds to a second row of discharge cells of the two adjacent rows of discharge cells, and
the bus electrode of the second scan electrode overlaps a discharge region of the second row of discharge cells.

23. The plasma display device of claim 22, the plasma display panel further comprising a plurality of black stripes extending on the side of the second substrate facing the first substrate and being substantially in parallel with the scan electrodes and the sustain electrodes,
wherein the first scan electrode, the second scan electrode and the sustain electrode extend between and are substantially in parallel with two corresponding black stripes of the plurality of black stripes.

24. The plasma display device of claim 23, wherein the plurality of black stripes comprise a conductive material.

25. The plasma display device of claim 24, wherein the conductive material comprises a material selected from the group consisting of Cr—Cu—Cr and Ag.

26. The plasma display device of claim 23, wherein each of the plurality of black stripes overlaps a corresponding one of the barrier ribs.
